(19) United States
(12) Patent Application Publication
(10) Pub. No.: US 2025/0237845 A1
(43) Pub. Date: Jul. 24, 2025

(54) OPTICAL ELEMENT DRIVING MECHANISM

(71) Applicant: TDK TAIWAN CORP., Taoyuan City (TW)

(72) Inventors: Chao-Yuan CHANG, Taoyuan City (TW); Po-Xiang ZHUANG, Taoyuan City (TW); Jui-Ta CHIEN, Taoyuan City (TW); Wei-Jhe SHEN, Taoyuan City (TW)

(21) Appl. No.: 19/027,361

(22) Filed: Jan. 17, 2025

Related U.S. Application Data
(60) Provisional application No. 63/624,551, filed on Jan. 24, 2024.

(51) Int. Cl. G02B 7/08; G02B 27/64

(52) U.S. Cl. CPC G02B 7/08; G02B 27/646

(57) ABSTRACT

An optical element driving mechanism is provided, which includes a first movable portion, a fixed portion, a first driving assembly, and a guiding assembly. The first movable portion is used for connecting to an optical element. The first movable portion is movable relative to the fixed portion. The first driving assembly is used for driving the first movable portion to move relative to the fixed portion. The guiding assembly is used for guiding the first movable portion to move relative to the fixed portion.

### CROSS REFERENCE TO RELATED APPLICATIONS

This application claims the benefit of U.S. Provisional Application No. 63/624,551, filed on 2024 Jan. 24, the entirety of which is incorporated by reference herein.

### BACKGROUND OF THE INVENTION

### Field of the Invention

The present invention relates to an optical element driving mechanism.

### Description of the Related Art

As technology has developed, it has become more common to include image-capturing and video-recording functions into many types of modem electronic devices, such as smartphones and digital cameras. These electronic devices are used more and more often, and new models have been developed that are convenient, thin, and lightweight, offering more choice to consumers.

Electronic devices that have image-capturing or video-recording functions normally include a driving mechanism to drive an optical element (such as a lens) to move along its optical axis, thereby achieving auto focus (AF) or optical image stabilization (OIS). Light may pass through the optical element and may form an image on an optical sensor. However, the trend in modern mobile devices is to have a smaller size and a higher durability. As a result, how to effectively reduce the size of the optical system and how to increase its durability has become an important issue.

### BRIEF SUMMARY OF THE INVENTION

An optical element driving mechanism is provided in some embodiments of the present disclosure, which includes a first movable portion, a fixed portion, a first driving assembly, and a guiding assembly. The first movable portion is used for connecting to an optical element. The first movable portion is movable relative to the fixed portion. The first driving assembly is used for driving the first movable portion to move relative to the fixed portion. The guiding assembly is used for guiding the first movable portion to move relative to the fixed portion.

In some embodiments, the guiding assembly includes a first intermediate element, and the first intermediate element includes a first main body, a first accommodating portion located on the first main body and having a recessed or opening structure, and a first contact unit disposed on the first accommodating portion. The first movable portion includes a first contact portion contacting the first intermediate element and movable relative to the first intermediate element, a second contact portion contacting the first intermediate element and movable relative to the first intermediate element, a third contact portion contacting the first intermediate element and movable relative to the first intermediate element. The first movable portion and the fixed portion are arranged along a main axis. The first contact portion and the second contact portion are arranged along a first axis when viewed along the main axis. The second contact portion and the third contact portion are arranged along a second axis when viewed along the main axis. The first axis and the second axis are not parallel.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a schematic view of an optical element driving mechanism.

FIG. 1B is an exploded view of the optical element driving mechanism.

FIG. 1C is a top view of the optical element driving mechanism.

FIG. 2A is a cross-sectional view taken along line A-A of FIG. 1C.

FIG. 2B is a cross-sectional view taken along line B-B of FIG. 1C.

FIG. 2C is a cross-sectional view taken along line C-C of FIG. 1C.

FIG. 2D is a cross-sectional view taken along line D-D of FIG. 1C.

FIG. 2E is a cross-sectional view taken along line E-E of FIG. 1C.

FIG. 3A is a bottom view of the first intermediate element and the first movable portion.

FIG. 3B is a top view of the first intermediate element and the second movable portion.

FIG. 4A, FIG. 4B, and FIG. 4C are cross-sectional views of some elements of the first intermediate element.

FIG. 5 is a side view of the second movable portion, the second intermediate element, and the third intermediate element.

FIG. 6A, FIG. 6B, FIG. 6C, FIG. 6D, and FIG. 6E are schematic views illustrating the connections between the second movable portion with the first and second intermediate elements.

### DETAILED DESCRIPTION OF THE INVENTION

The following disclosure provides many different embodiments, or examples, for implementing different features of the provided subject matter. Specific examples of elements and arrangements are described below to simplify the present disclosure. These are, of course, merely examples and are not intended to be limiting. For example, in some embodiments, the formation of a first feature over or on a second feature in the description that follows may include embodiments in which the first and second features are in direct contact, and may further include embodiments in which additional features may be disposed between the first and second features, such that the first and second features may not be in direct contact.

In addition, the present disclosure may repeat reference numerals and/or letters in the various examples. This repetition is for the purpose of simplicity and clarity and does not in itself dictate a relationship between the various embodiments and/or configurations discussed. Moreover, the formation of a feature on, connected to, and/or coupled to another feature in the present disclosure that follows may include embodiments in which the features are in direct contact, and may further include embodiments in which additional features may be disposed interposing the features, such that the features may not be in direct contact. In addition, spatially relative terms, for example, “vertical,” “above,” “over,” “below,”, “bottom,” etc. as well as derivatives thereof (e.g., “downwardly,” “upwardly,” etc.) are used in the present disclosure for ease of description of one feature's relationship to another feature. The spatially relative terms are intended to cover different orientations of the device, including the features.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

In addition, in some embodiments of the present disclosure, terms concerning attachments, coupling and the like, such as “connected” and “interconnected”, refer to a relationship wherein structures are secured or attached to one another either directly or indirectly through intervening structures, as well as both movable or rigid attachments or relationships, unless expressly described otherwise.

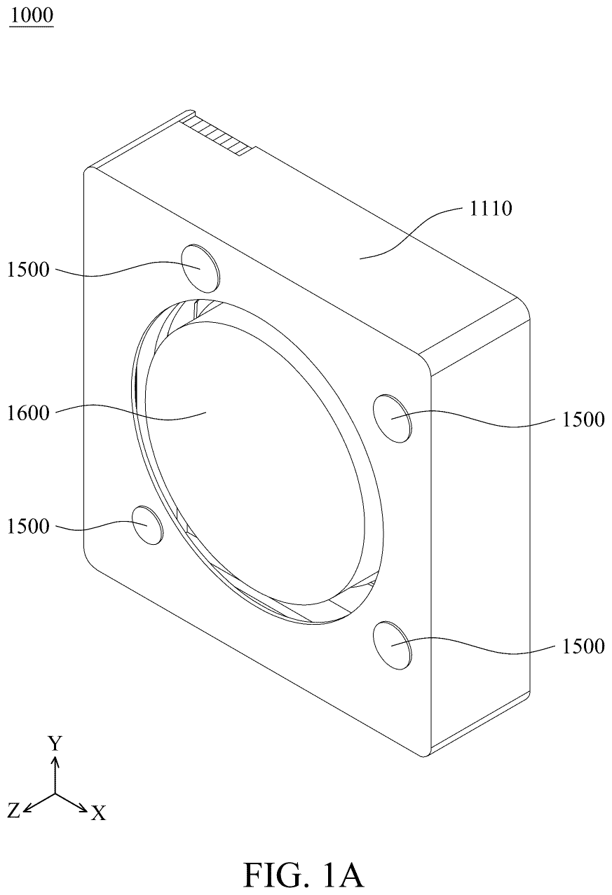

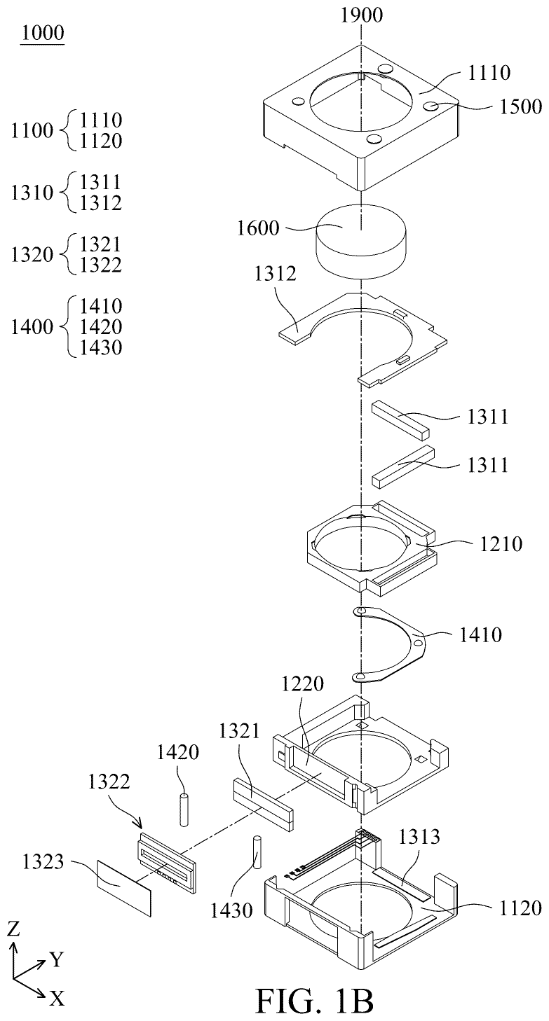

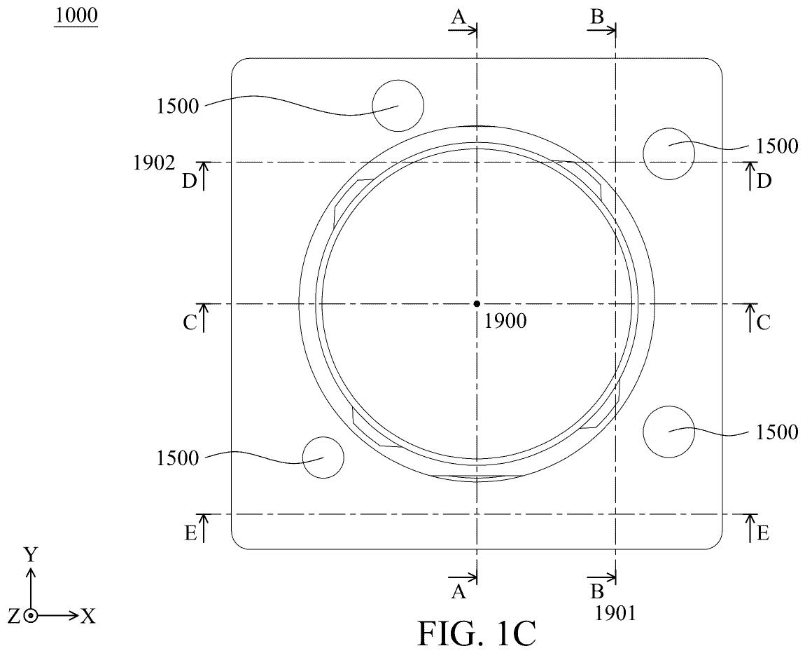

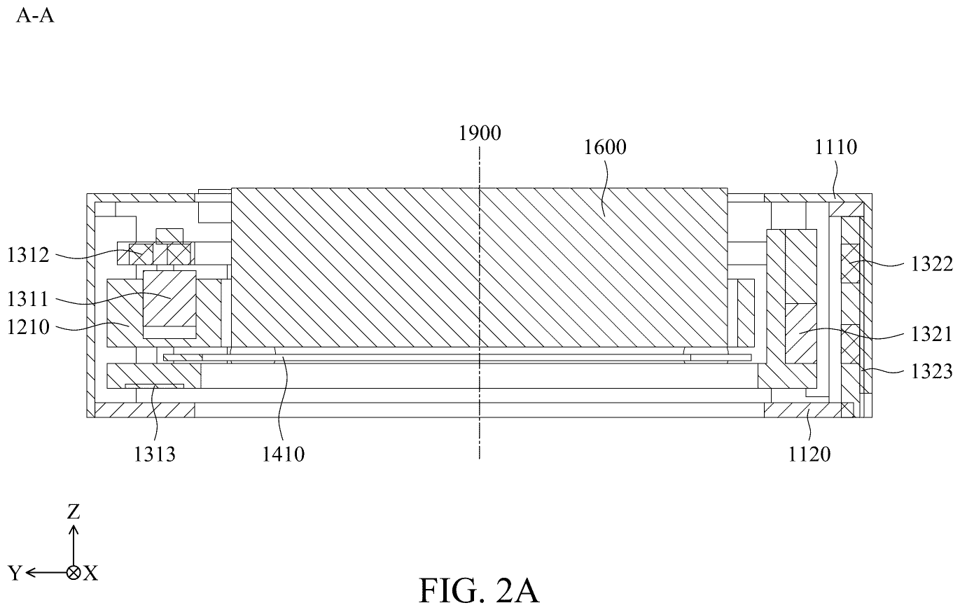

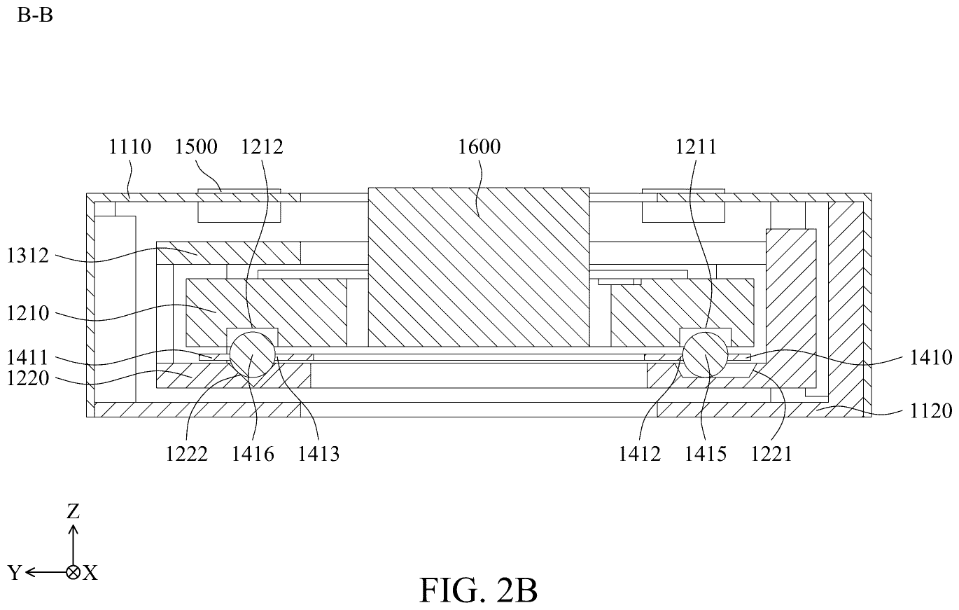

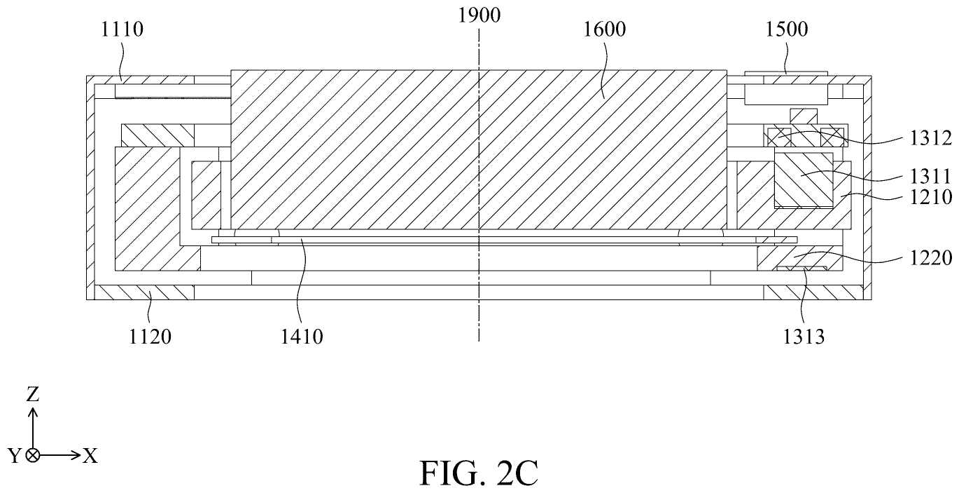

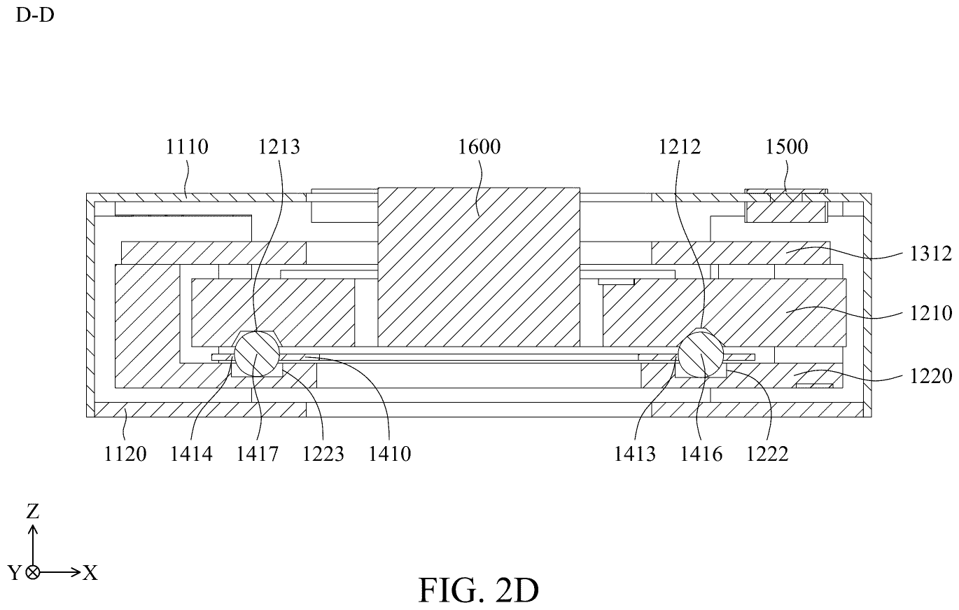

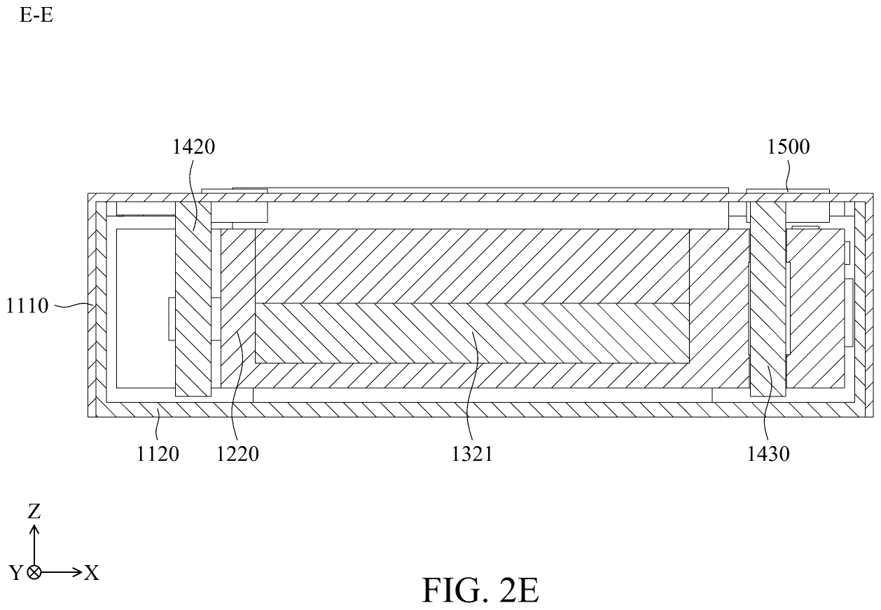

Embodiments of the present disclosure provide an optical element driving mechanism for driving an optical element to move. For example, FIG. 1A is a schematic view of an optical element driving mechanism 1000, FIG. 1B is an exploded view of the optical element driving mechanism 1000, FIG. 1C is a top view of the optical element driving mechanism 1000, FIG. 2A is a cross-sectional view taken along the line segment A-A of FIG. 1C, FIG. 2B is a cross-sectional view taken along the line segment B-B of FIG. 1C, FIG. 2C is a cross-sectional view taken along the line segment C-C of FIG. 1C, FIG. 2D is a cross-sectional view taken along the line segment D-D of FIG. 1C, and FIG. 2E is a cross-sectional view taken along the line segment E-E of FIG. 1C.

As shown in FIG. 1A to FIG. 2E, the optical element driving mechanism 1000 mainly includes a fixed portion 1100 (including an case 1110 and a base 1120), a first movable portion 1210, a second movable portion 1220, a first driving assembly 1310 (including a first magnetic element 1311 and a first coil 1312), a second driving assembly 1320 (including a second magnetic element 1321 and a second coil 1322), a first magnetic permeable element 1313, a second magnetic permeable element 1323, a guiding assembly 1400 (including a first intermediate element 1410, a second intermediate element 1420, and a third intermediate element 1430), and a buffering element 1500 arranged along a main axis 1900 and used for holding an optical element 1600 to move.

In some embodiments, the optical element 1600 may be, for example, a lens, a mirror, a prism, a reflective polished surface, an optical coating, a beam splitter, an aperture, a liquid lens, an image sensor, a camera module, or a ranging module. It should be noted that the definition of the optical element is not limited to the element that is related to visible light, and other elements that relate to invisible light (e.g. infrared or ultraviolet) are also included in the present disclosure.

In some embodiments, the case 1110 and the base 1120 may be combined to form a shell of the optical element driving mechanism 1000, and the other elements of the optical element driving mechanism 1000 may be disposed in the shell formed by the case 1110 and the base 1120 to protect these elements. For example, the base 1120 may be affixed to the case 1110. It should be understood that the case 1110 and the base 1120 are respectively formed with an case opening and a base opening, where the center of the case opening corresponds to the main axis 1900 passing through the optical element 1600, and the base opening corresponds to a optical sensor (not shown) located outside the optical element driving mechanism 1000. Accordingly, the optical element 1600 disposed within the optical element driving mechanism 1000 may be focused on the optical sensor along the Y direction in which the main axis 1900 extends.

In some embodiments, the first movable portion 1210 may be disposed in the second movable portion 1220, and the first movable portion 1210 is used for connecting to the optical element 1600. The second movable portion 1220 may be disposed in the fixed portion 1100. In some embodiments, the first movable portion 1210 may move relative to the second movable portion 1220, the second movable portion 1220 may move relative to the fixed portion 1100, and the directions of movement of the first movable portion 1210 and the second movable portion 1220 may be different from each other to allow the optical element 1600 to move relative to the fixed portion 1100 in different directions. For example, the first movable portion 1210 may have a through hole, and the optical element 1600 may be affixed in the through hole to move together with the first movable portion 1210.

In some embodiments, the first driving assembly 1310 may be used to drive the first movable portion 1210 to move relative to the fixed portion 1100 or the second movable portion 1220, and the second driving assembly 1320 may be used to drive the second movable portion 1220 to move relative to the fixed portion 1100. For example, as shown in FIG. 2A, the first magnetic element 1311 may be disposed on the first movable portion 1210, and the first coil 1312 may be disposed on the second movable portion 1220. When power is provided to the first coil 1312, the first coil 1312 interacts with the magnetic field of the first magnetic element 1311 to generate an electromagnetic force to drive the first movable portion 1210 and the optical element 1600 to move relative to the second movable portion 1220 and the fixed portion 1100. Additionally, the second magnetic element 1321 may be disposed on the second movable portion 1220, and the second coil 1322 may be disposed on the base 1120. When power is provided to the second coil 1322, the second coil 1322 interacts with the magnetic field of the second magnetic element 1321 to generate an electromagnetic force to drive the second movable portion 1220 to move relative to the fixed portion 1100, so functions such as Auto Focus (AF) or Optical Image Stabilization (OIS) may be achieved. In some embodiments, the positions of the first magnetic element 1311 and the first coil 1312 may be interchanged, or the positions of the second magnetic element 1321 and the second coil 1322 may be interchanged, depending on design requirements.

In some embodiments, as shown in FIG. 2A and FIG. 2C, the first magnetic permeable element 1313 may correspond to the first magnetic element 1311, such as may be arranged along the Z axis. The second magnetic permeable element 1323 corresponds to the second magnetic element 1321, such as may be arranged along the Y axis. The first magnetic permeable element 1313 and the second magnetic permeable element 1323 may include magnetic permeable materials, such as may include metals. Therefore, the magnetic flux of the first magnetic element 1311 and the second magnetic element 1321 may be modulated to enhance the driving performance. In some embodiments, the first magnetic permeable element 1313 may be disposed on the second movable portion 1220 or on the base 1120, so that the magnetic attraction between the first magnetic element 1311 and the first magnetic permeable element 1313 allows the first intermediate element 1410 to be clamped between the first movable portion 1210 and the second movable portion 1220. The second magnetic permeable element 1323 may be disposed on the base 1120, so that the magnetic attraction between the second magnetic element 1321 and the second magnetic permeable element 1323 causes the second movable portion 1220 to lean toward the second intermediate element 1420 and the third intermediate element 1430.

In some embodiments, as shown in FIG. 2B, the first intermediate element 1410 may be disposed between the first movable portion 1210 and the second movable portion 1220 to movably connect the first movable portion 1210 and the second movable portion 1220. For example, the first intermediate element 1410 may be disposed between the first movable portion 1210 and the second movable portion 1220 by frictional contact. As shown in FIG. 2E, the second intermediate element 1420 and the third intermediate element 1430 may have strip shapes and extending parallel to the main axis 1900, and may be disposed between the second movable portion 1220 and the fixed portion 1100, such as between the second movable portion 1220 and the base 1120 to movably connect the fixed portion 1100 and the second movable portion 1220. This allows the second movable portion 1220 to move relative to the fixed portion 1100 along the Z axis to achieve auto focus.

For example, the second intermediate element 1420 and the third intermediate element 1430 may be disposed on the second movable portion 1220 by frictional contact and affixed on the fixed portion 1100 (e.g., base 1120). In some embodiments, the second intermediate element 1420 and the third intermediate element 1430 may also be affixed on the second movable portion 1220 and disposed on the fixed portion 1100 (e.g., base 1120) by frictional contact, depending on design requirements.

In some embodiments, the buffering element 1500 may be disposed on the case 1110 and partially exposed from the case 1110, so that when additional element (e.g., an aperture) is disposed on the case 1110, the buffering element 1500 may serve as a cushion between them to avoid direct collision. In some embodiments, the buffering element 1500 may include a soft material, such as rubber.

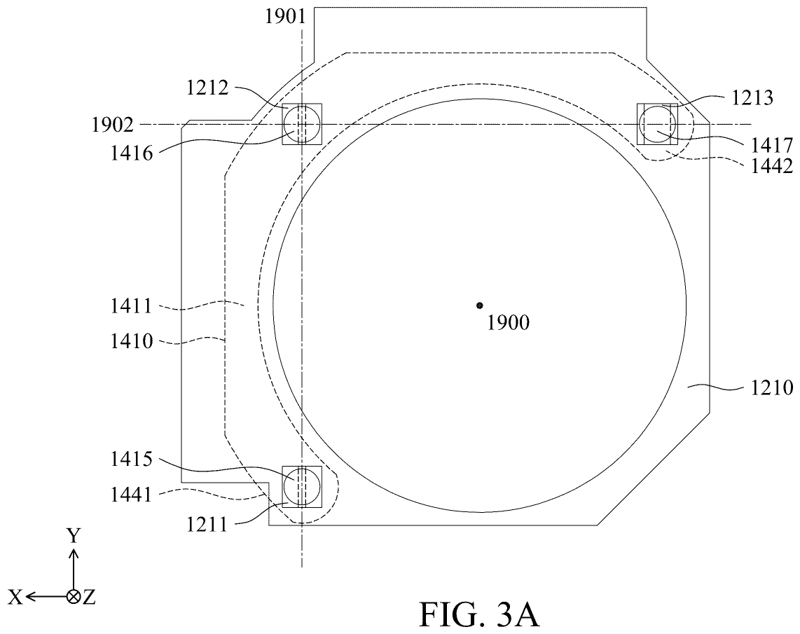

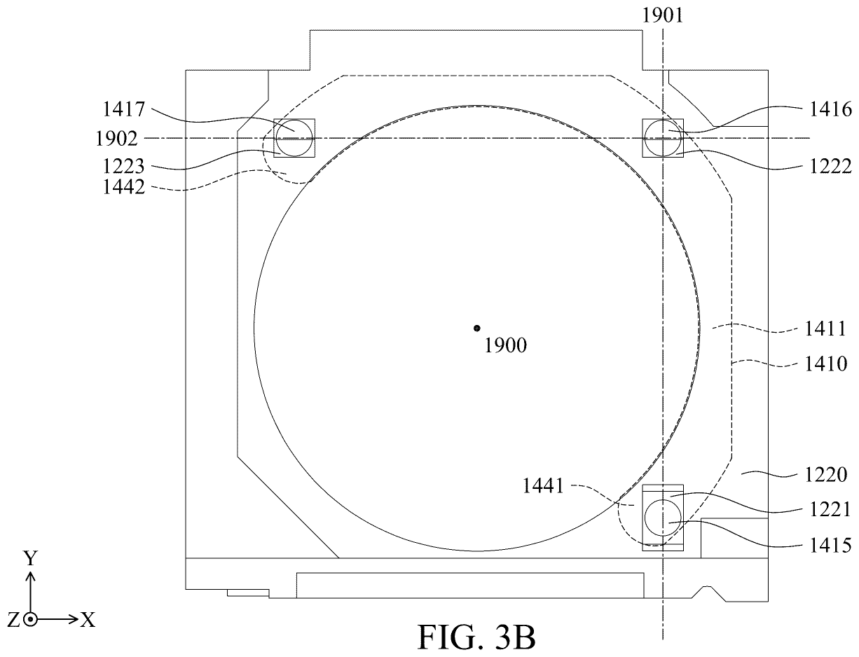

FIG. 3A is a bottom view of the first intermediate element 1410 and the first movable portion 1210, and FIG. 3B is a top view of the first intermediate element 1410 and the second movable portion 1220. As shown in FIG. 2B, FIG. 2D, FIG. 3A, and FIG. 3B, the first intermediate element 1410 may mainly include a first main body 1411, a first accommodating portion 1412, a second accommodating portion 1413, a third accommodating portion 1414, and a first contact unit 1415, a second contact unit 1416, and a third contact unit 1417 disposed in the first accommodating portion 1412, the second accommodating portion 1413, and the third accommodating portion 1414, respectively. The first accommodating portion 1412, the second accommodating portion 1413, and the third accommodating portion 1414 are located on the first main body 1411 and may have recessed or opening structures.

In some embodiments, the first contact unit 1415, the second contact unit 1416, and the third contact unit 1417 may be partially disposed in the first contact portion 1211, the second contact portion 1212, and the third contact portion 1213 of the first movable portion 1210, respectively, and respectively contact the first contact portion 1211, the second contact portion 1212, and the third contact portion 1213. In addition, the first contact unit 1415, the second contact unit 1416, and the third contact unit 1417 may be partially disposed in the fourth contact portion 1221, the fifth contact portion 1222, and the sixth contact portion 1223 of the second movable portion 1220, respectively, and respectively contact the fourth contact portion 1221, the fifth contact portion 1222, and the sixth contact portion 1223 to reduce the size of the optical element driving mechanism 1000 in the direction along the main axis 1900 (the direction that the Z axis extends) to achieve miniaturization.

In some embodiments, as shown in FIG. 2B and FIG. 2D, the first contact portion 1211, the first contact unit 1415, and the fourth contact portion 1221 at least partially overlap with each other along the direction that the main axis 1900 extends (the Z direction), the second contact portion 1212, the second contact unit 1416, and the fifth contact portion 1222 at least partially overlap with each other, and the third contact portion 1213, the third contact unit 1417, and the sixth contact portion 1223 at least partially overlap with each other.

In some embodiments, as shown in FIG. 3A and FIG. 3B, when viewed along the main axis 1900, the first main body 1411 may have an L-shape, such as may be disposed on two of the edges of the first movable portion 1210 or the second movable portion 1220. The first contact unit 1415 may be located at a first end 1441 of the first main body 1411, and the third contact unit 1417 may be located at a second end 1442 of the first main body 1411, and the first end 1441 and the second end 1442 may be located at two ends of the first main body 1411.

In some embodiments, the first contact unit 1415, the second contact unit 1416, and the third contact unit 1417 may, for example, have a spherical or hemispherical curved surface shape to reduce the contact area between the first intermediate element 1410 and the first movable portion 1210 and the second movable portion 1220. Therefore, the friction between the first intermediate element 1410 and the first movable portion 1210 and the second movable portion 1220 may be reduced to allow the first intermediate element 1410 to movably connect the first movable portion 1210 and the second movable portion 1220.

The first intermediate element 1410 may be used to guide the first movable portion 1210 to move relative to the second movable portion 1220 in a specific direction. For example, as shown in FIG. 3A, the first contact portion 1211, the second contact portion 1212, and the third contact portion 1213 of the first movable portion 1210 may have grooves extending in the Y direction to allow the first intermediate element 1410 to move relative to the first movable portion 1210 along the Y direction.

Furthermore, as shown in FIG. 3B, the fourth contact portion 1221, the fifth contact portion 1222, and the sixth contact portion 1223 of the second movable portion 1220 may have grooves extending in the X direction to allow the first intermediate element 1410 to move relative to the second movable portion 1220 along the X direction. In other words, the first movable portion 1210 may move relative to the second movable portion 1220 through the first intermediate element 1410 in the XY plane to achieve optical image stabilization. Moreover, since the first intermediate element 1410 may be disposed on the XY plane, the size of the optical element driving mechanism 1000 in the Z axis may be reduced to achieve miniaturization.

As shown in FIG. 3A, the first contact portion 1211 and the second contact portion 1212 may be arranged along a first axis 1901, and the second contact portion 1212 and the third contact portion 1213 may be arranged along a second axis 1902. In addition, as shown in FIG. 3B, the fourth contact portion 1221 and the fifth contact portion 1222 may be arranged along the first axis 1901, and the fifth contact portion 1222 and the sixth contact portion 1223 may be arranged along the second axis 1902. In some embodiments, the first axis 1901 and the second axis 1902 are not parallel. For example, the first axis 1901 may extend in the Y direction, and the second axis 1902 may extend in the X direction, i.e., the first axis 1901 and the second axis 1902 may be perpendicular to each other.

In some embodiments, as shown in FIG. 2B and FIG. 3B, the structures of the fourth contact portion 1221 and the fifth contact portion 1222 may be different from each other. For example, the fourth contact portion 1221 may have a U-shaped structure, and the fifth contact portion 1222 may have a V-shaped structure. In some embodiments, the sixth contact portion 1223 may also have a V-shaped structure. As a result, the direction of movement of the first intermediate element 1410 relative to the second movable portion 1220 may be restricted, and assembly of the first intermediate element 1410 with the second movable portion 1220 may be allowed even in the presence of assembly tolerances.

In some embodiments, as shown in FIG. 2D and FIG. 3A, the structures of the second contact portion 1212 and the third contact portion 1213 may be different from each other. For example, the second contact portion 1212 may have a V-shaped structure, and the third contact portion 1213 may have a U-shaped structure. In some embodiments, the first contact portion 1211 may also have a V-shaped structure. Therefore, the movement direction of the first intermediate element 1410 relative to the first movable portion 1210 may be restricted, and assembly of the first intermediate element 1410 with the first movable portion 1210 may be allowed even in the presence of assembly tolerances.

Although in the aforementioned embodiments specific contact portions are limited to having V-shaped or U-shaped structures, the present disclosure is not limited thereto. For example, one of the first contact portion 1211, the second contact portion 1212, and the third contact portion 1213 may have a U-shaped structure, and the other two may have V-shaped structures. For instance, the bottom surface size of the third contact portion 1213 may be larger than that of the first contact portion 1211 or the second contact portion 1212, which means that the third contact portion 1213 has a U-shaped structure, but the present disclosure is not limited thereto. In some embodiments, the bottom surface size of one of the first contact portion 1211, the second contact portion 1212, or the third contact portion 1213 may different from the other two, such as the bottom surface size of one of the first contact portion 1211, the second contact portion 1212, or the third contact portion 1213 may be larger than the other two.

In addition, one of the fourth contact portion 1221, fifth contact portion 1222, and sixth contact portion 1223 may have a U-shaped structure, and the other two may have V-shaped structures. For example, the bottom surface size of the sixth contact portion 1223 may be larger than that of the fourth contact portion 1221 or the fifth contact portion 1222, which means that the sixth contact portion 1223 has a U-shaped structure, but the present disclosure is not limited thereto. In some embodiments, the bottom surface size of one of the fourth contact portion 1221, the fifth contact portion 1222, or the sixth contact portion 1223 may different from the other two, such the bottom surface size of one of the fourth contact portion 1221, the fifth contact portion 1222, or the sixth contact portion 1223 may be larger than the other two. This helps to avoid errors caused by assembly tolerances.

It should be noted that because the aforementioned first contact unit 1415, second contact unit 1416, and third contact unit 1417 are clamped by the first movable portion 1210 and the second movable portion 1220, the movable directions of the first intermediate element 1410, the first movable portion 1210, and the second movable portion 1220 are restricted. As a result, when the first movable portion 1210 moves relative to the second movable portion 1220, they will not flip or rotate relative to each other, which reduces the difficulty of driving and improves the precision of the driving.

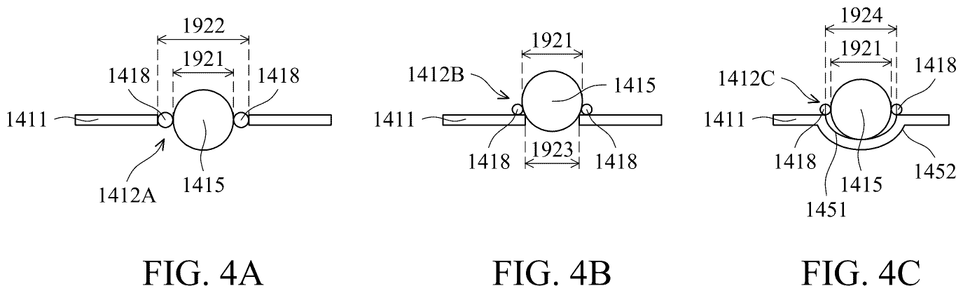

FIG. 4A, FIG. 4B, and FIG. 4C are cross-sectional views of some elements of the first intermediate element 1410, which mainly shows different embodiments of the connections between the first main body 1411, the first accommodating portion, and the first contact unit 1415. It should be noted that these connection relationships may also apply to the second accommodating portion and the second contact unit 1416, as well as to the third accommodating portion and the third contact unit 1417, and thus will not be described again here. In these embodiments, the size of the first accommodating portion may be different from the size of the first contact unit 1415.

In some embodiments, as shown in FIG. 4A, the first accommodating portion 1412A may have an opening structure. The first contact unit 1415 may be disposed in the first accommodating portion 1412A, and the first contact unit 1415 may be connected to the first main body 1411 through a connecting element 1418. In some embodiments, the connecting element 1418 may include adhesives, welding materials, or the like. In some embodiments, the first contact unit 1415 may have a size 1921 (such as when the first contact unit 1415 is spherical, the size 1921 may be its diameter), and the first accommodating portion 1412A may have a size 1922, and the size 1921 may be smaller than the size 1922. This allows portions of the first contact unit 1415 on both sides of the first main body 1411 to have similar sizes.

In some embodiments, as shown in FIG. 4B, the first accommodating portion 1412B may have an opening structure. The first contact unit 1415 may be partially disposed in the first accommodating portion 1412B, and the first contact unit 1415 may be connected to the first main body 1411 through the connecting element 1418. In some embodiments, the first contact unit 1415 may have a size 1921, and the first accommodating portion 1412B may have a size 1923, with size 1921 being larger than size 1923. This prevents the first contact unit 1415 from falling out of the first accommodating portion 1412B.

In some embodiments, as shown in FIG. 4C, the first accommodating portion 1412C may have a grooved structure, and the first contact unit 1415 may be partially disposed in the first accommodating portion 1412C. The first contact unit 1415 may be connected to the first main body 1411 through the connecting element 1418. In some embodiments, the first contact unit 1415 may have a size 1921, and the first accommodating portion 1412C may have a size 1924, The size 1921 may be smaller than the size 1924 to allow the first contact unit 1415 being disposed in the first accommodating portion 1412C. In some embodiments, the first contact unit 1415 may directly contact a first surface 1451 of the first accommodating portion 1412C, and the first accommodating portion 1412C may directly contact the first contact portion 1211 or the fourth contact portion 1221 by a second surface 1452 opposite to the first surface 1451 to allow the first intermediate element 1410 to move relative to the first movable portion 1210 or the second movable portion 1220.

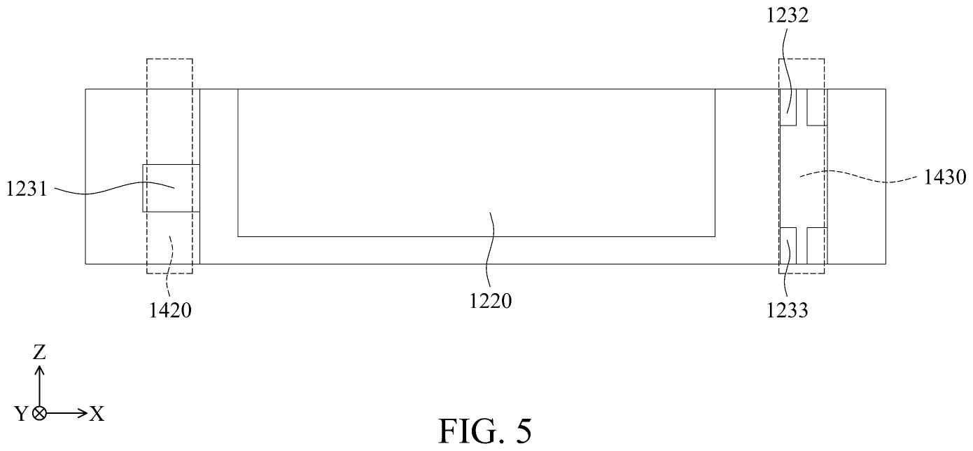

FIG. 5 is a side view of the second movable portion 1220, the second intermediate element 1420, and the third intermediate element 1430. As shown in FIG. 5, the second movable portion 1220 may include a first support portion 1231, a second support portion 1232, and a third support portion 1233. The first support portion 1231 may directly contact the second intermediate element 1420, and the second support portion 1232 and the third support portion 1233 may directly contact the third intermediate element 1430. Therefore, the second movable portion 1220 may contact the second intermediate element 1420 and the third intermediate element 1430 at three points. Since three points define a plane, this connection method may prevent the second movable portion 1220 from tilting.

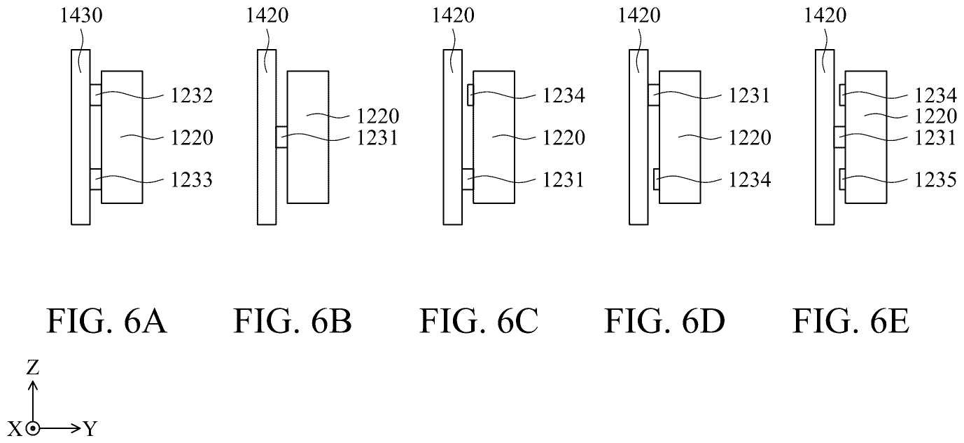

FIG. 6A, FIG. 6B, FIG. 6C, FIG. 6D, and FIG. 6E are schematic views of connections between the second movable portion 1220, the third intermediate element 1430, and the second intermediate element 1420. As shown in FIG. 6A, the third intermediate element 1430 may directly contact the second support portion 1232 and the third support portion 1233 of the second movable portion 1220. In some embodiments, as shown in FIG. 6B, the second intermediate element 1420 directly contacts the first support portion 1231 of the second movable portion 1220.

In some embodiments, as shown in FIG. 6C, a first auxiliary support portion 1234 may be disposed on the second movable portion 1220 adjacent to the second intermediate element 1420. The first auxiliary support portion 1234 may be arranged with the first support portion 1231 along the main axis 1900 (Z axis). For example, the first auxiliary support portion 1234 may be located above the first support portion 1231. In other words, the distance between the first auxiliary support portion 1234 and the base 1120 may be greater than the distance between the first support portion 1231 and the base 1120 along the Z axis. Moreover, the size of the first auxiliary support portion 1234 may be smaller than the size of the first support portion 1231 in a direction perpendicular to the main axis 1900. In other words, under normal conditions, the first support portion 1231 may directly contact the second intermediate element 1420, and the first auxiliary support portion 1234 does not contact the second intermediate element 1420, which means there is a gap between the first auxiliary support portion 1234 and the second intermediate element 1420. If the optical element driving mechanism 1000 is subjected to an impact causing the second movable portion 1220 to tilt, the first auxiliary support portion 1234 may then contact the second intermediate element 1420 to prevent collisions between the second intermediate element 1420 and other parts of the second movable portion 1220, thereby protecting the second intermediate element 1420 and the second movable portion 1220.

In some embodiments, as shown in FIG. 6D, a first auxiliary support portion 1234 may be provided on the second movable portion 1220 adjacent to the second intermediate element 1420. The first auxiliary support portion 1234 may be arranged with the first support portion 1231 along the main axis 1900 (Z axis), such as the first auxiliary support portion 1234 may be located below the first support portion 1231. That is, the distance between the first auxiliary support portion 1234 and the base 1120 may be less than the distance between the first support portion 1231 and the base 1120 along the Z axis.

In some embodiments, as shown in FIG. 6E, a first auxiliary support portion 1234 and a second auxiliary support portion 1235 may be disposed on the second movable portion 1220 adjacent to the second intermediate element 1420. The first auxiliary support portion 1234, the first support portion 1231, and the second auxiliary support portion 1235 may be arranged sequentially along the main axis 1900, and the first support portion 1231 may be located between the first auxiliary support portion 1234 and the second auxiliary support portion 1235. In other words, the first auxiliary support portion 1234 and the second auxiliary support portion 1235 may be positioned on opposite sides of the first support portion 1231.

In some embodiments, in the direction perpendicular to the main axis 1900, sizes of the first auxiliary support portion 1234 and the second auxiliary support portion 1235 are smaller than the size of the first support portion 1231. Therefore, under normal conditions, both the first auxiliary support portion 1234 and the second auxiliary support portion 1235 will space apart from the second intermediate element 1420 for a distance. If the optical element driving mechanism 1000 is subjected to an impact causing the second movable portion 1220 to tilt, whether tilting upward or downward, the second movable portion 1220 may contact either the first auxiliary support portion 1234 or the second auxiliary support portion 1235 to protect the second intermediate element 1420 and the second movable portion 1220.

It should be noted that when the optical element 1600 of the present disclosure moves in the XY plane, the first intermediate element 1410 may movably connect the first movable portion 1210 and the second movable portion 1220 to allow the optical element 1600 to move in the XY plane relative to the fixed portion 1100 along with the first movable portion 1210 and the second movable portion 1220 to achieve optical image stabilization. When the optical element 1600 moves along the Z direction, the second intermediate element 1420 and the third intermediate element 1430 may be used to movably connect the second movable portion 1220 and the fixed portion 1100 to allow the optical element 1600 moving along the Z axis relative to the fixed portion 1100 together with the first movable portion 1210 and the second movable portion 1220, thereby achieving auto focus. By using two different mechanisms to separately accomplish optical image stabilization and auto focus functions, it can be ensured that these functions do not interfere with each other during operation to improve the precision of driving and sensing.

In summary, an optical element driving mechanism is provided in some embodiments of the present disclosure, which includes a first movable portion, a fixed portion, a first driving assembly, and a guiding assembly. The first movable portion is used for connecting to an optical element. The first movable portion is movable relative to the fixed portion. The first driving assembly is used for driving the first movable portion to move relative to the fixed portion. The guiding assembly is used for guiding the first movable portion to move relative to the fixed portion. This configuration achieves auto focus, optical image stabilization, and zooming, and also enabling miniaturization.

The relative positions and size relationship of the elements in the present disclosure may allow the driving mechanism achieving miniaturization in specific directions or for the entire mechanism. Moreover, different optical modules may be combined with the driving mechanism to further enhance optical quality, such as the quality of photographing or accuracy of depth detection. Therefore, the optical modules may be further utilized to achieve multiple anti-vibration systems, so image stabilization may be significantly improved.

Although embodiments of the present disclosure and their advantages already have been described in detail, it should be understood that various changes, substitutions and alterations may be made herein without departing from the spirit and the scope of the disclosure as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are also intended to include within their scope of such processes, machines, manufacture, and compositions of matter, means, methods, or steps. In addition, each claim herein constitutes a separate embodiment, and the combination of various claims and embodiments are also within the scope of the disclosure.

What is claimed is:

1. An optical element driving mechanism, comprising:
a first movable portion used for connecting a first optical element;
a fixed portion, wherein the first movable portion is movable relative to the fixed portion;
a first driving assembly used for driving the first movable portion to move relative to the fixed portion; and
a guiding assembly used for guiding the first movable portion to move relative to the fixed portion.

2. The optical element driving mechanism as claimed in claim 1, wherein the guiding assembly comprises a first intermediate element, and the first intermediate element comprises:
a first main body;
a first accommodating portion located on the first main body and having a recessed or opening structure; and
a first contact unit disposed on the first accommodating portion.

3. The optical element driving mechanism as claimed in claim 2, wherein the first movable portion comprises:
a first contact portion contacting the first intermediate element and movable relative to the first intermediate element;
a second contact portion contacting the first intermediate element and movable relative to the first intermediate element; and
a third contact portion contacting the first intermediate element and movable relative to the first intermediate element.

4. The optical element driving mechanism as claimed in claim 3, wherein:
the first movable portion and the fixed portion are arranged along a main axis;
the first contact portion and the second contact portion are arranged along a first axis when viewed along the main axis;
the second contact portion and the third contact portion are arranged along a second axis when viewed along the main axis;
the first axis and the second axis are not parallel.

5. The optical element driving mechanism as claimed in claim 4, further comprising a second movable portion movably connected to the fixed portion, wherein the first axis and the second axis are perpendicular.

6. The optical element driving mechanism as claimed in claim 5, wherein the first intermediate element further comprises:
a second accommodating portion located on the first main body and having a recessed or opening structure;
a third accommodating portion located on the first main body and having a recessed or opening structure;
a second contact unit disposed on the second accommodating portion; and
a third contact unit disposed on the third accommodating portion.

7. The optical element driving mechanism as claimed in claim 6, wherein the second movable portion comprises:
a fourth contact portion contacting the first intermediate element and being movable relative to the first intermediate element;
a fifth contact portion contacting the first intermediate element and being movable relative to the first intermediate element; and
a sixth contact portion contacting the first intermediate element and being movable relative to the first intermediate element.

8. The optical element driving mechanism as claimed in claim 7, wherein:
the fourth contact portion and the fifth contact portion are arranged along the first axis when viewed along the main axis;
the fifth contact portion and the sixth contact portion are arranged along the second axis when viewed along the main axis.

9. The optical element driving mechanism as claimed in claim 8, wherein:
the first contact portion at least partially overlaps with the first contact unit in a direction that the main axis extends;
the second contact portion at least partially overlaps with the second contact unit in the direction that the main axis extends;
the third contact portion at least partially overlaps with the third contact unit in the direction that the main axis extends;
the fourth contact portion at least partially overlaps with the first contact unit in the direction that the main axis extends;
the fifth contact portion at least partially overlaps with the second contact unit in the direction that the main axis extends;
the sixth contact portion at least partially overlaps with the third contact unit in the direction that the main axis extends.

10. The optical element driving mechanism as claimed in claim 9, wherein:
the first contact portion at least partially overlaps with the fourth contact portion in the direction that the main axis extends;
the second contact portion at least partially overlaps with the fifth contact portion in the direction that the main axis extends;
the third contact portion at least partially overlaps with the sixth contact portion in the direction that the main axis extends.

11. The optical element driving mechanism as claimed in claim 10, wherein:
a size of a bottom surface of at least one of the first contact portion, the second contact portion, and the third contact portion is different from a size of a bottom surface of the other two in a direction that the second axis extends;
a size of a bottom surface of at least one of the fourth contact portion, the fifth contact portion, and the sixth contact portion is different from a size of a bottom surface of the other two in a direction that the first axis extends.

12. The optical element driving mechanism as claimed in claim 11, wherein:
the first contact unit is partially in the first contact portion;
the second contact unit is partially in the second contact portion;
the third contact unit is partially in the third contact portion;
the first contact unit is partially in the fourth contact portion;
the second contact unit is partially in the fifth contact portion;
the third contact unit is partially in the sixth contact portion.

13. The optical element driving mechanism as claimed in claim 12, wherein:
the size of the bottom surface of the third contact portion is greater than the size of the bottom surface of the first contact portion or the second contact portion in the direction that the second axis extends; and
the size of the bottom surface of the sixth contact portion is greater than the size of the bottom surface of the fourth contact portion or the fifth contact portion in the direction that the first axis extends.

14. The optical element driving mechanism as claimed in claim 4, further comprising a second movable portion movable relative to the first movable portion;
wherein:
the guiding assembly comprises a second intermediate element and a third intermediate element disposed on the fixed portion;
the second movable portion comprises:
a first support portion contacting the second intermediate element and being movable relative to the second intermediate element;
a second support portion contacting the third intermediate element and being movable relative to the third intermediate element; and
a third support portion contacting the third intermediate element and being movable relative to the third intermediate element.

15. The optical element driving mechanism as claimed in claim 14, wherein:
the first movable portion and the fixed portion are arranged along a main axis;
the second movable portion further comprises a first auxiliary support portion and a second auxiliary support portion arranged with the first support portion along the main axis.

16. The optical element driving mechanism as claimed in claim 15, wherein:
the first auxiliary support portion is spaced apart from the second intermediate element;
the second auxiliary support portion is spaced apart from the second intermediate element;
a size of the first auxiliary support portion is smaller than a size of the first support portion in a direction perpendicular to the main axis;
a size of the second auxiliary support portion is smaller than the size of the first support portion in the direction perpendicular to the main axis.

17. The optical element driving mechanism as claimed in claim 16, wherein:
the first auxiliary support portion and the second auxiliary support portion are disposed on opposite sides of the first support portion in the direction that the main axis extends;
a size of the first accommodating portion is different from a size of the first contact unit.

18. The optical element driving mechanism as claimed in claim 17, wherein:
the first intermediate element further comprises a connecting element disposed between the first main body and the first contact unit;
the size of the first accommodating portion is greater than the size of the first contact unit.

19. The optical element driving mechanism as claimed in claim 18, wherein:
the first main body comprises a first surface and a second surface;
the first surface is opposite to the second surface;
the first contact unit directly contacts the first surface;
the second surface directly contacts one of the first movable portion or the second movable portion.

20. The optical element driving mechanism as claimed in claim 19, wherein the size of the first accommodating portion is smaller than the size of the first contact unit.
